(19) United States
(12) Patent Application Publication
(10) Pub. No.: US 2025/0297346 A1
(43) Pub. Date: Sep. 25, 2025

(54) LOW WEIGHT HYDROGEN DISTRIBUTION SYSTEM AND COMPONENTS

(71) Applicant: Poppe + Potthoff GmbH, Werther (DE)

(72) Inventors: Katrin KOHLMEYER, Bielefeld (DE); Frank SCHNEIDEWIND, Bielefeld (DE); David-Daniel BÜCKERT, Bielefeld (DE); Burkhard HARHOFF, Bielefeld (DE); Christian KRONHOLZ, Dülmen (DE); Björn RIXE, Bielefeld (DE)

(21) Appl. No.: 18/262,307

(22) PCT Filed: Jan. 20, 2022
(86) PCT No.: PCT/EP2022/051238

§ 371 Date: Jul. 20, 2023

(30) Foreign Application Priority Data
Jan. 20, 2021 (EP) 21152585.2

(51) Int. Cl. C22C 38/22; B32B 15/01; B60K 15/03; C22C 38/00; C22C 38/02; C22C 38/04; H01M 8/04082

(52) U.S. Cl. CPC C22C 38/22; C22C 38/002; C22C 38/02; C22C 38/04; H01M 8/04216; B32B 15/013; B32B 2311/20; B32B 2597/00; B60K 15/03; B60K 2015/03315

(57) ABSTRACT

The present disclosure relates to a hydrogen-carrying component for a fuel distribution system of an energy conversion system which can be operated at a pressure range from at least 0.1 MPa, comprising a base body, at least one gas conduit in the main body, at least one gas inlet and at least one gas outlet, which are in fluid communication via the at least one gas conduit, the base body being substantially made of a tempered steel having the following composition: 0.18 to 0.45% by weight of carbon, 0.15 to 0.40% by weight of silicon, 0.4 to 1.0% by weight of manganese, 0.4 to 1.2% by weight of chromium, 0.08 to 0.35% by weight of molybdenum, at most 0.035% by weight of phosphorus, at most 0.04% by weight of sulfur, iron and smelting-related steel accompanying elements; wherein the tempered steel has the following properties: a tensile strength in the range from 650 MPa to 950 MPa; a yield strength or a 0.2% elasticity limit in the range from 500 MPa to 850 MPa; and an elongation at break in the range from 12% to 35%.

The disclosure also relates to a hydrogen distribution system, an energy conversion plant, and a drive system for vehicles.

### 1. TECHNICAL FIELD

The invention relates to low-weight hydrogen-conducting components and low-weight hydrogen distribution systems constructed therefrom, in particular for drive trains of vehicles, which are manufactured from a tempered steel.

### 2. STATE OF THE ART

With an energy density of approximately 120 MJ/kg and due to the emission-free oxyhydrogen reaction (2 H₂+O₂→2 H₂O), molecular hydrogen (H₂) is an ideal fuel for heat engines (e.g. gas turbines and combustion engines) and fuel cells.

Conventional H₂ distribution systems (e.g. in the drive train of a vehicle or in the fuel supply of a stationary plant for power generation) are typically manufactured from austenitic stainless steel (e.g. of type 1.4435, less frequently of type 1.4571) with a high nickel content (usually>12.5% by weight). For this material class it is known that it has a face-centered cubic crystal lattice and thereby the problem of hydrogen embrittlement, which occurs in particular at high gas pressure, can be avoided (cf. Materials Science and Technology, Volume 33, Issue 13 (2017)).

However, conventional austenitic stainless steel is expensive (inter alia because of the high nickel and molybdenum content). EP 2 850 215 B1 therefore proposes an austenitic steel without molybdenum and with a reduced nickel content of 6 to 9% by weight.

The mechanical properties of austenitic steel are also often poorly suited to producing H₂ distribution systems, in particular when modern high-pressure tanks are used. For example, the austenitic stainless steel of type 1.4435 usually has only a tensile strength of less than 600 MPa, a 0.2% elasticity limit of less than 250 MPa and an elongation at break of more than 45%. The typically high weight of H₂ components manufactured from such a material can be a decisive disadvantage in particular for drive trains of modern H₂-driven vehicles (e.g. passenger cars, trucks, rail vehicles, aircraft, ships, drones, etc.).

Furthermore, austenitic stainless steels can also be processed more difficultly and/or require unusual processing methods, so that, for example, for the mass production of H₂ distribution systems for combustion engines or fuel cells, new production plants must be installed or existing ones must be retrofitted in a complex manner. Taken together, the outlined disadvantages of

H₂ distribution systems which are manufactured from austenitic stainless steel represent a significant hurdle for the large-scale use of H₂ energy technology.

In this context, EP 2 278 035 B1 discloses a material with good H₂ embrittlement properties and a tensile strength in the range from 900 MPa to

950 MPa, having the following composition:
0.10 to 0.20% by weight of carbon,
0.10 to 0.40% by weight of silicon,
0.50 to 1.20% by weight of manganese,
0.75 to 1.75% by weight of nickel,
0.20 to 0.80% by weight of chromium,
0.31 to 0.50% by weight of copper,
0.10 to 1.00% by weight of molybdenum,
0.01 to 0.10% by weight of vanadium,
0.0005 to 0.005% by weight of boron,
less than 0.01% by weight of nitrogen,
0.01 to 0.10% by weight of niobium and/or 0.005 to 0.050% by weight of titanium;
otherwise iron and unavoidable impurities.

However, the production and the constituents of such a material are likewise complex and expensive and therefore inadequately suited in particular for the mass production of H₂ distribution systems.

It is thus the object underlying the present invention to reduce at least partially some of the above-described disadvantages of the state of the art.

### 3. SUMMARY OF THE INVENTION

The above-mentioned problem is at least partially solved by the subject matter of the independent claim of the present application. Exemplary embodiments are described in the dependent claims.

In one embodiment, the present invention provides a hydrogen-carrying component for a fuel distribution system of an energy conversion system which is operable in a pressure range of at least 0.1 MPa and comprises a base body, at least one gas line in the base body and at least one gas inlet and at least one gas outlet which are in fluid connection via the at least one gas line. The base body is substantially made of a tempered steel having the following composition:
0.18 to 0.45% by weight of carbon,
0.15 to 0.40% by weight of silicon,
0.4 to 1.0% by weight of manganese,
0.4 to 1.2% by weight of chromium,
0.08 to 0.35% by weight of molybdenum,
at most 0.035% by weight of phosphorus,
at most 0.04% by weight of sulfur,
iron and smelting-related steel accompanying elements. The tempered steel from which the base body is substantially made further has the following properties:
a tensile strength in the range from 650 MPa to 950 MPa,
a yield strength or a 0.2% elasticity limit in the range from 500 MPa to 850 MPa, and
an elongation at break in the range from 12% to 35%.

Unless stated otherwise, material properties are to be determined according to the relevant industrial standards (e.g. according to ISO 6892-1). Further, here and in the following, the term “substantially” is to be understood as “within typical design, measurement and/or manufacturing tolerances”. Likewise, it is to be understood that depending on whether the tempered steel is obtained from ores or from recycled material, different steel accompanying elements can be present.

The above-specified hydrogen-conducting component can be, for example, a pipe (see FIG. 2), a valve (see FIGS. 3A and 3B), a T-piece, a pressure reducer, a filter, a flow limiter, or a common distributor (e.g. FIG. 1) or combine at least two of these functions in one common component.

The base body of the component can be constructed such that it withstands an internal gas pressure of at least 30 MPa, preferably of at least 70 MPa and more preferably of at least 100 MPa in continuous operation.

In particular, the part of the base body enclosing the gas conduit can have a maximum wall thickness in the range of only 0.8 mm-9 mm, preferably in the range of

1 mm-6 mm and more preferably in the range of 1 mm-5 mm.

H₂ distribution systems can thus be manufactured from such components, which have a significantly lower weight compared to the state of the art, but are nevertheless (high) pressure-resistant, as well as resistant to hydrogen-induced embrittlement and can be easily processed (e.g. CNC milling, drilling, bending and/or welding). In contrast to the state of the art, long-term proven manufacturing methods can be used, which are also used, for example, in the manufacture of diesel drive trains.

It has been shown that the resistance to hydrogen-induced embrittlement of the components and distribution systems described here can be further improved by the tempered steel having a defect depth of at most 5% of the wall thickness on an inner side of the at least one gas conduit. In particular, the defect depth can be at most 200 μm, preferably at most 130 μm.

It is further advantageous, in particular for high-pressure components and high-pressure distribution systems having a small wall thickness and good forming and joining properties, that the carbon content of the tempered steel of the base body is in the range from 0.18 to 0.33% by weight, preferably in the range from 0.22 to 0.29% by weight.

The embrittlement resistance of the described components and distribution systems can further be improved by the phosphorus content of the tempered steel being less than or equal to 0.025% by weight, and/or by the sulfur content of the tempered steel being less than or equal to 0.010% by weight.

For particularly high demands on the described components and distribution systems (e.g. on the pressure resistance, the H₂ compatibility and/or the forming and joining properties), the tensile strength of the tempered steel can be in the range from 700 MPa to 950 MPa, preferably in the range from 750 MPa to 950 MPa, even more preferably in the range from 750 MPa to 900 MPa, and/or

the yield strength or the 0.2% elasticity limit of the tempered steel is in the range from 600 MPa-850 MPa, more preferably in the range from 650 MPa to 800 MPa, and/or the elongation at break of the tempered steel is in the range from 13% to 30%, preferably in the range from 14% to 28%, and even more preferably in the range from 15% to 25%.

For example, the described components can comprise at least two subunits which are connected by at least one welded and/or at least one soldered connection.

Further, in some embodiments of the present invention, an outer surface of the base body of the respective component can be coated with at least one of the following coatings: a zinc-nickel coating; a galvanic coating; a coating produced by electrophoretic deposition or a powder coating.

In this case, the selected coating can be corrosion-resistant (e.g. to red rust) for at least 96 hours, preferably for at least 150 hours and more preferably for at least 720 hours according to DIN EN ISO 9227, in order to be able to ensure continuous use of the described components and system even in the open air and under difficult weather or environmental conditions (e.g. spray water with diffused salt dissolved therein).

The material properties of the tempered steel from which the base body of the above-described hydrogen-conducting components is substantially made can be achieved, for example, in that in a first step a suitable starting material (e.g. a hot pipe or similar semi-finished product) is cold-formed in order to obtain the desired mechanical strength by the cold-working of the microstructure. Subsequently, the formed starting material can be subjected to an annealing process in order to obtain the desired above-specified mechanical properties. Finally, for quality control, the resulting properties of the material can be determined, and suitable semi-finished products can be selected.

In a further embodiment, the present invention provides a hydrogen distribution system for an energy conversion system which comprises at least one first hydrogen-conducting component as described above and preferably at least one second hydrogen-conducting component as described above, wherein the two components are in fluid communication—for example via a screw connection, a compression head with union nut and/or a welded connection and/or a soldered connection.

For example, such a hydrogen distribution system can comprise a high-pressure section and preferably a low-pressure section and a pressure reducer connecting the high-pressure section to the low-pressure section, wherein the high-pressure section is designed for an operating pressure of at least 30 MPa, preferably of at least 70 MPa and more preferably of at least 100 MPa.

The high-pressure section can comprise one or more of the following components: an outer tank valve or an inner tank valve, a filter, a check valve, a pressure relief valve, at least one filling conduit and at least one withdrawal conduit; a coalescence filter, a T-piece; a filling nozzle, a common distributor, and a solenoid valve.

Such distribution systems are suitable inter alia because of their low weight in particular for the drive train of H₂ vehicles such as aircraft, drones, trains, ships, or motor vehicles with H₂ drive and/or H₂ power generation systems.

For example, a stationary or mobile energy conversion system can comprise the following components: a hydrogen supply line or a hydrogen tank, a hydrogen combustion engine, a hydrogen gas turbine and/or a fuel cell; and a hydrogen distribution system as described above which supplies the hydrogen from the supply line or the tank to the combustion engine, the gas turbine and/or the fuel cell.

Further, an H₂ propulsion system for a vehicle can comprise at least one high pressure hydrogen tank, a hydrogen combustion engine, a hydrogen gas turbine and/or a fuel cell and a hydrogen distribution system as described above, wherein the hydrogen distribution system supplies the hydrogen from the at least one high pressure hydrogen tank to the combustion engine, the gas turbine and/or the fuel cell.

### 4. DESCRIPTION OF THE DRAWINGS

Certain aspects of the present invention are described below with reference to the attached drawings. In the drawings:

FIG. 1 a subsystem of a hydrogen distribution system for a hydrogen combustion engine according to an embodiment of the present invention;

FIG. 2 a Z-shaped hydrogen distribution tube with compression heads and union nuts according to an embodiment of the present invention;

FIG. 3A a check valve for a valve assembly according to an embodiment of the present invention;

FIG. 3B a longitudinal section through the valve body of the valve of FIG. 3A.

### 5. DETAILED DESCRIPTION OF SOME EXEMPLARY EMBODIMENTS

Some exemplary embodiments of the present invention are described below using the example of some exemplary distribution systems and components for H₂ drive trains of a motor vehicle. However, the present invention can likewise also be used in other vehicles such as ships, trains, aircraft, or drones and in mobile or stationary systems for energy conversion or power generation. Various combinations of features are described here with reference to the illustrated embodiments of the present invention. Of course, not all features of the described embodiments have to be present in order to realize the present invention. Furthermore, the embodiments can be modified by combining certain features of one embodiment with one or more features of another embodiment—if this is technically compatible and expedient—without departing from the disclosure and the scope of protection of the present invention which is defined by the claims.

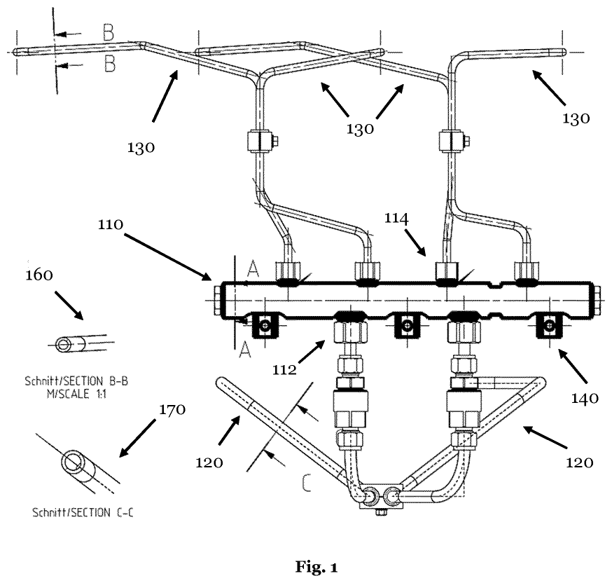

FIG. 1 shows a subsystem of an H₂ high-pressure distribution system for a four-cylinder H₂ combustion engine according to an embodiment of the present invention. The distribution system here comprises a common distributor 110 with two gas inlet connections 112 which are fed via two gas feed lines 120. In the present embodiment, the gas feed lines 120 have an outer diameter of 10 mm and an inner diameter of 7 mm (see cross section 170 of the gas feed line 120). The wall thickness of the two feed lines 120 is thus 1.5 mm in this embodiment.

The common distributor 110 can be fastened via fastening blocks 140 e.g. to the combustion engine (e.g. via screw connections). Since the fastening blocks 140 do not come into contact with the hydrogen, they can also be manufactured from a different material than the base body of the hydrogen-conducting components of the illustrated H₂ distribution system (see section 2 above). The common distributor 110 further has four output connections 114 to each of which an H₂ distribution pipe 130 is connected which conducts H₂ gas to an associated injection device of the associated combustion cylinder (not illustrated). The distribution pipes 130 have an outer diameter of 6.35 mm and an inner diameter of 4 mm. The wall thickness of the distribution pipes 130 is thus 1.125 mm (see cross section 160 of the distribution pipes 120).

The illustrated distribution system and in particular the pipe diameters of the gas feed lines 120 and the distribution pipes 130 are designed for operation with an H₂ high-pressure tank with a gas pressure of 30 MPa. However, the present invention also comprises H₂ components and H₂ distribution systems which are designed for higher operating pressures (e.g. 70 MPa or 100 MPa).

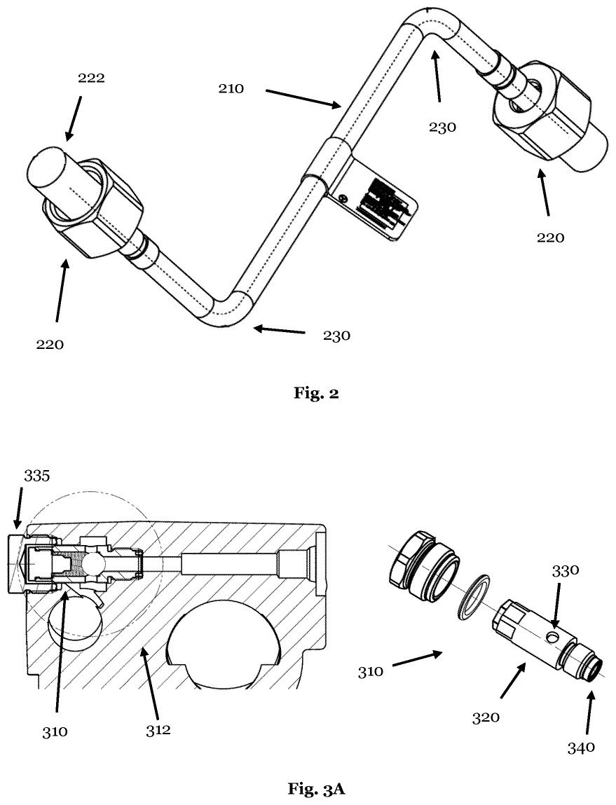

FIG. 2 shows a Z-shaped H₂ distribution tube 210 according to an embodiment of the present invention. The tube 210 can be connected via two compression heads 222 with union nuts 220 to other components of an H₂ distribution system. The material properties of the tempered steel from which the base body of the distribution tube 210 (and optionally the compression heads and union nuts) are manufactured (see section 2 above) allow highly bent tubes with narrow bending radii to be manufactured without impairing the pressure resistance of the distribution tube 210. For example, the bending radius can be in the range from 1.5 to 2.2 of the tube diameter.

In order to protect the distribution tube 210 against external influences (e.g. against corrosion), the outer surface of the base body of the distribution tube 210 (and optionally the outer surfaces of the compression heads 222 and of the union nuts 220) is coated with a coating. For example, a zinc-nickel coating, a galvanic coating, a coating produced by electrophoretic deposition (e.g. a cathodic dip coating) or a powder coating can be used for this purpose as described above. Preferably, such a coating is corrosion-resistant (e.g. to red rust) for at least 96 h, more preferably for at least 150 h and even more preferably for at least 720 hours according to DIN EN ISO 9227. Such a coating can also be used for the H₂ components illustrated in FIG. 1 or other components as described above.

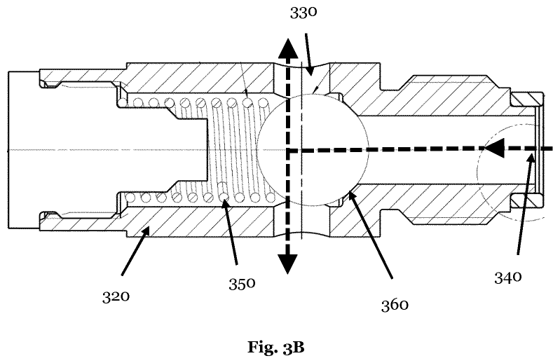

FIG. 3A shows a further hydrogen-carrying H₂ component according to a further embodiment of the present invention. This is a check valve 310, which can be used for example in a valve assembly 312 or a filling conduit (not illustrated). The check valve 310 comprises a valve body 320 with an axially arranged gas inlet 340 and two radially arranged gas outlets 330 and a closure cap 335.

The valve body 320 and optionally the closure cap 335 are made of a tempered steel as described in section 2 above. This makes it possible to manufacture check valves with low wall thickness and good H₂ embrittlement properties, which are pressure-resistant and have a lower weight compared to the state of the art and which can likewise be easily manufactured. The base body 320 of the check valve 310 can be easily CNC milled and/or drilled for example without its H₂ compatibility and pressure resistance being impaired. In this case, low wall thicknesses (for example in the range from 0.8 mm to 5 mm) can be realized and a high-pressure resistance in continuous operation and an operating pressure of up to 100 MPa or more can nevertheless be ensured.

FIG. 3B shows a longitudinal section through the base body 320 of the check valve 310 of FIG. 3A. The gas flow from the gas inlet 340 to the two gas outlets 330 is illustrated by the dashed arrow. In the illustrated configuration, the valve is closed by a check spring 350 pressing a metallic sealing ball 360 against a sealing surface of the valve base body 320. If the H₂ gas pressure at the gas inlet 340 exceeds the sealing pressure provided by the check spring 350, the check valve opens and the H₂ gas can flow from the gas inlet 340 to the two gas outlets 330.

According to the present invention, the valve base body 320 and optionally the sealing ball 360 as well as optionally the check spring 350 are made of a tempered steel as described in section 2 above. This makes it possible to manufacture H₂ compatible and high-pressure-resistant check valves (as well as other valve types or H₂ components) which have a low weight and are very well suited for mass production.

The weight reduction and efficiency gains made possible by the present invention can therefore make a substantial contribution to helping the environmentally friendly H₂ energy technology to break through.

What is claimed is:

1. Hydrogen-carrying component for a fuel distribution system of an energy conversion system operable in a pressure range of at least
0.1 MPa, comprising:
a base body;
at least one gas conduit in the base body;
at least one gas inlet and at least one gas outlet in fluid communication via the at least one gas conduit;
wherein the base body is substantially made of a tempered steel
having the following composition:
0.18 to 0.45% by weight of carbon,
0.15 to 0.40% by weight of silicon,
0.4 to 1.0% by weight of manganese,
0.4 to 1.2% by weight of chromium,
0.08 to 0.35% by weight of molybdenum,
at most 0.035% by weight of phosphorus,
at most 0.04% by weight of sulfur,
iron and smelting-related steel accompanying elements;
wherein the tempered steel has the following properties:
a tensile strength in the range from 650 MPa to 950 MPa;
a yield strength or a 0.2% elasticity limit in the range from 500 MPa to 850 MPa; and
an elongation at break in the range from 12% to 35%.

2. Hydrogen-conducting component according to claim 1, wherein the tempered steel has a defect depth of at most 200 μm, preferably of at most 130 μm, on a inner side of the at least one gas conduit.

3. Hydrogen-conducting component according to one of the preceding claims, wherein the carbon content of the tempered steel is in the range from 0.18 to 0.33% by weight, preferably in the range from 0.22 to 0.29% by weight.

4. Hydrogen-conducting component according to one of the preceding claims, wherein the phosphorus content of the tempered steel is less than or equal to 0.025% by weight, and/or wherein the sulfur content of the tempered steel is less than or equal to 0.010% by weight.

5. Hydrogen-conducting component according to one of the preceding claims, wherein the tensile strength of the tempered steel is in the range from 700 MPa to 950 MPa, preferably in the range from 750 MPa to 950 MPa, even more preferably in the range from 750 MPa to 900 MPa; and/or
wherein the yield strength or the 0.2% elasticity limit of the tempered steel is in the range from 600 MPa to 850 MPa, more preferably in the range from 650 MPa to 800 MPa; and/or
wherein the elongation at break of the tempered steel is in the range from 13%-30%, preferably in the range from 14% to 28%, even more preferably in the range from 15%-25%.

6. Hydrogen-conducting component according to one of the preceding claims, wherein the part of the base body enclosing the gas conduit has a maximum wall thickness in the range from 0.8 mm to 9.0 mm, preferably in the range from 1.0 mm to 6.0 mm, more preferably in the range from 1.0 mm to 5.0 mm.

7. Hydrogen-conducting component according to one of the preceding claims, wherein the component comprises at least two subunits which are connected by at least one welded and/or at least one soldered connection.

8. Hydrogen-conducting component according to one of the preceding claims, wherein the component is a pipe, a valve, a T-piece, a pressure reducer, a filter, a flow limiter or a common distributor, or combines at least two of these functions in one component.

9. Hydrogen-conducting component according to one of the preceding claims, wherein the base body withstands an internal gas pressure of at least 30 MPa, preferably of at least 70 MPa and more preferably of at least 100 MPa in continuous operation.

10. Hydrogen-conducting component according to one of the preceding claims, wherein an outer surface of the base body is coated with at least one of the following coatings: a zinc-nickel coating; a galvanic coating; a coating produced by electrophoretic deposition or a powder coating.

11. Hydrogen distribution system for an energy conversion system comprising at least one first hydrogen-conducting component according to one of the preceding claims 1-10 and preferably at least one second hydrogen-conducting component according to one of the preceding claims 1-10 which are in fluid communication.

12. Hydrogen distribution system according to claim 11, comprising a high-pressure section and preferably a low-pressure section and a pressure reducer connecting the high-pressure section to the low-pressure section, wherein the high-pressure section is designed for an operating pressure of at least 30 MPa, preferably of at least 70 MPa, more preferably of at least 100 MPa.

13. Hydrogen distribution system according to claim 12, wherein the high-pressure section comprises one or more of the following components: an outer tank valve or an inner tank valve, a filter, a check valve, at least one filling conduit and at least one withdrawal conduit; a coalesence filter, a T-piece; a filling nozzle, a common distributor and a solenoid valve.

14. Stationary or mobile energy conversion system comprising:
a hydrogen supply line or a hydrogen tank;
a hydrogen combustion engine, a hydrogen gas turbine and/or
a fuel cell; and
a hydrogen distribution system according to one of claims 11-13 which supplies hydrogen from the supply line or the tank to the combustion engine, the gas turbine and/or the fuel cell.

15. A hydrogen propulsion system for a vehicle comprising:
at least one high pressure hydrogen tank;
a hydrogen combustion engine, a hydrogen gas turbine and/or a fuel cell; and
a hydrogen distribution system according to one of claims 11-13 which supplies the hydrogen from the at least one high pressure hydrogen tank to the combustion engine, the gas turbine and/or the fuel cell.
